(19) United States
(12) Patent Application Publication
(10) Pub. No.: US 2009/0250473 A1
(43) Pub. Date: Oct. 8, 2009

(54) CONVERTIBLE INSULATED COOKING UTENSIL

(76) Inventors: David J. Bois, Kansas City, MO (US); Eugene T. Logan, Salina, KS (US)

Correspondence Address: THOMPSON & THOMPSON, P.A., P.O BOX 166, SCANDIA, KS, 66966, US

(21) Appl. No.: 12/398,065

(22) Filed: Mar. 4, 2009

Related U.S. Application Data
(60) Provisional application No. 61/033,854, filed on Mar. 5, 2008.

(51) Int. Cl. A47J 37/01

(52) U.S. Cl. 220/573.1

(57) ABSTRACT

An insulated cooking utensil has a first pan with a cooking surface, a second pan having a shape corresponding to the first pan, and an alignment structure for aligning the first pan relative to the second pan when the pans are assembled together. The alignment structure allows the first and second pans to be separated from each other. The cooking utensil is convertible between a first configuration in which the first pan is nested with the second pan with an insulating air chamber interposed between the first and second pans, and a second configuration in which the second pan is turned upside down and placed over the first pan as a protective cover. A locking structure can be used to releasably secure the first and second pans together in the first and second configurations. Additional pans can be interchanged with the first pan to provide a different shaped cooking surface.

### RELATED APPLICATIONS

This application claims priority of U.S. Provisional Application No. 61/033,854 filed on Mar. 5, 2008. The content of this prior application is incorporated herein by reference.

### BACKGROUND OF THE INVENTION

1. Field of the Invention

The present invention relates generally to improvements in cookware. In particular, the present invention relates to insulated cooking utensils and covers for such cooking utensils.

2. Description of the Related Art

Cooking time is often critical when preparing foods, and overcooking may be detrimental to the final quality of the cooked food. This problem is particularly prevalent when baking foods in an oven because over-baking can ruin the food. For example, cakes will lose moisture and dry out relatively quickly if permitted to stay in the oven longer than the prescribed time, although they may also be underdone if removed from the oven prematurely. In addition, there is often a wide variation in the way different ovens cook because some ovens are apparently “hotter” than other ovens, even though the temperature controls are at the same temperature setting. As a result, there is little tolerance in the baking time for many foods.

Insulated cooking utensils, such as cookie sheets and cake pans, have been developed in the past to alleviate the critical baking time during common baking procedures. Such insulated cooking utensils are typically constructed of first and second pieces of aluminum sheets formed in the shape of a cookie sheet or a cake pan and secured together at their outer peripheries with an insulating air chamber formed between the pieces. These insulated cooking utensils have become very popular and widely available in the marketplace. Examples of these prior art insulated cooking utensils are described in U.S. Pat. Nos. 4,489,852 and 4,595,120.

The insulated cooking utensils described above are typically made of two pieces of aluminum sheet material secured together at their outer peripheries by crimping an outer edge of one of the sheets around the outer edge of the other sheet. The sheets are thus permanently fixed together with an insulating air chamber between the sheets. However, if the cooking utensil is submersed in wash water, the water can sometimes enter the insulating air chamber, either through the crimped peripheral edges or through drain holes provided in one of the pieces. This creates a cooking utensil that either seeps water during storage or emits the water as steam during baking. There is no practical way to separate the two permanently attached sheets to clean or dry the inner surfaces of the insulating air chamber.

Cake pans and other baking pans are sometimes provided with covers to protect cakes or other baked items contained in the pans. For example, some insulated baking pans are provided with plastic or metal covers that can be attached to the pans after the pans are removed from the oven to protect the baked item until it is served. These covers are typically either snap-on covers or slide-on covers and do not include a secure locking feature capable of withstanding oven temperatures.

There remains a need in the industry for improvements in insulated cooking ware to address the problems described above and to enhance the convenience and functionality of such insulated cooking ware.

### SUMMARY OF THE INVENTION

An object of the present invention is to provide an improved insulated cooking utensil that overcomes the problems and shortcomings of the prior art described above.

Further objects of the present invention are to provide an improved insulated cooking utensil that easily separates into two individual pieces so that the inner surfaces of the insulating air chamber can be washed and dried; to provide an insulated cooking utensil that can be converted into a pan with a tall and durable cover; and to provide an insulated cooking utensil with two pans that are held together by a releasable locking mechanism.

To accomplish these and other objects of the present invention, an insulated cooking utensil is provided having a first pan with a cooking surface, a second pan having a shape corresponding to the first pan, and an alignment structure for aligning the first pan relative to the second pan when the pans are assembled together. The alignment structure can be in the form of a guide member with a dome-shaped upper surface that causes the first pan to self-align with the second pan during assembly, and allows the first and second pans to be easily separated from each other for washing. The cooking utensil is convertible between a first configuration in which the first pan is nested with the second pan with an insulating air chamber interposed between the first and second pans, and a second configuration in which the second pan is turned upside down and placed over the first pan as a protective cover. A locking structure can be used to releasably secure the first and second pans together in the first and second configurations. Additional pans can be interchanged with the first pan to provide a cooking surface having a different shape and purpose.

According to a broad aspect of the present invention, an insulated cooking utensil is provided, comprising: a first pan having a cooking surface; a second pan having a shape corresponding to the first pan so that the first and second pans can be assembled together with an insulating air chamber interposed between the first and second pans for insulating the cooking surface of the first pan from direct heat during a cooking operation; and an alignment structure for aligning the first pan relative to the second pan when the pans are assembled together and for allowing the first and second pans to be separated from each other.

According to another broad aspect of the invention, a convertible cooking utensil is provided, comprising: a first pan having a cooking surface; a second pan having a shape corresponding to the first pan; and an alignment structure for aligning the first pan relative to the second pan when the pans are assembled together and for allowing the first and second pans to be separated from each other. The cooking utensil is convertible from a first configuration in which the first pan is nested within the second pan with an insulating air chamber interposed between the first and second pans, and a second configuration in which the second pan is turned upside down and placed over the first pan as a protective cover.

Numerous other objects and features of the present invention will be apparent to those skilled in this art from the following description wherein there is shown and described embodiments of the present invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a perspective view of an insulated cooking utensil according to the present invention in a first assembled configuration for baking.

FIG. 2 is a perspective view of the first and second pans of the insulated cooking utensil in an unassembled condition.

FIG. 3 is a perspective view of the first and second pans of the insulated cooking utensil with the second pan inverted and positioned above the first pan.

FIG. 4 is a perspective view of the insulated cooking utensil in a second assembled configuration with the second pan placed on top of the first pan as a protective top cover.

FIG. 5 is a plan view of the insulated cooking utensil shown in FIG. 4.

FIG. 6 is a plan view of the insulated cooking utensil shown in FIG. 1.

FIG. 7 is a cross-section view of the cooking utensil as viewed along line 7-7 in FIG. 5.

FIG. 8 is a cross-section view of the cooking utensil as viewed along line 8-8 in FIG. 6.

FIG. 9 is a cross-section view of the cooking utensil as viewed along line 9-9 in FIG. 6.

FIG. 10 is a cross-section view of the cooking utensil as viewed along line 10-10 in FIG. 6.

FIG. 11 is a perspective view of an insulated cooking utensil according to a another embodiment of the present invention in which the cooking surface has a different shape and purpose.

FIG. 12 is a perspective view of another embodiment of the present invention in which the cooking surface has a different shape and purpose.

FIG. 13 is a plan view of a locking mechanism for securing the two pieces of the cooking utensil together, as shown in an unlocked position.

FIG. 14 is a plan view of the locking mechanism of FIG. 13 in a locked position.

FIG. 15 is a cross-section view of the locking mechanism with the two pieces of the cooking utensil assembled together in the first configuration for cooking.

FIG. 16 is a cross-section view of the locking mechanism with the two pieces of the cooking utensil assembled together in the second configuration with one of the pieces used as a top cover.

FIG. 17 is a perspective view of the locking mechanism shown in FIG. 13.

FIG. 18 is an exploded perspective view of the locking mechanism shown in FIG. 17.

FIG. 19 is a perspective view of a low profile insulated cooking utensil according to another embodiment of the present invention, as assembled in a first configuration for baking.

FIG. 20 is a perspective view of the first and second pans of the insulated cooking utensil of FIG. 19 in an unassembled condition.

FIG. 21 is a perspective view of the insulated cooking utensil of FIG. 19, as assembled in a second configuration with the second pan placed on top of the first pan as a protective top cover.

### DETAILED DESCRIPTION OF THE INVENTION

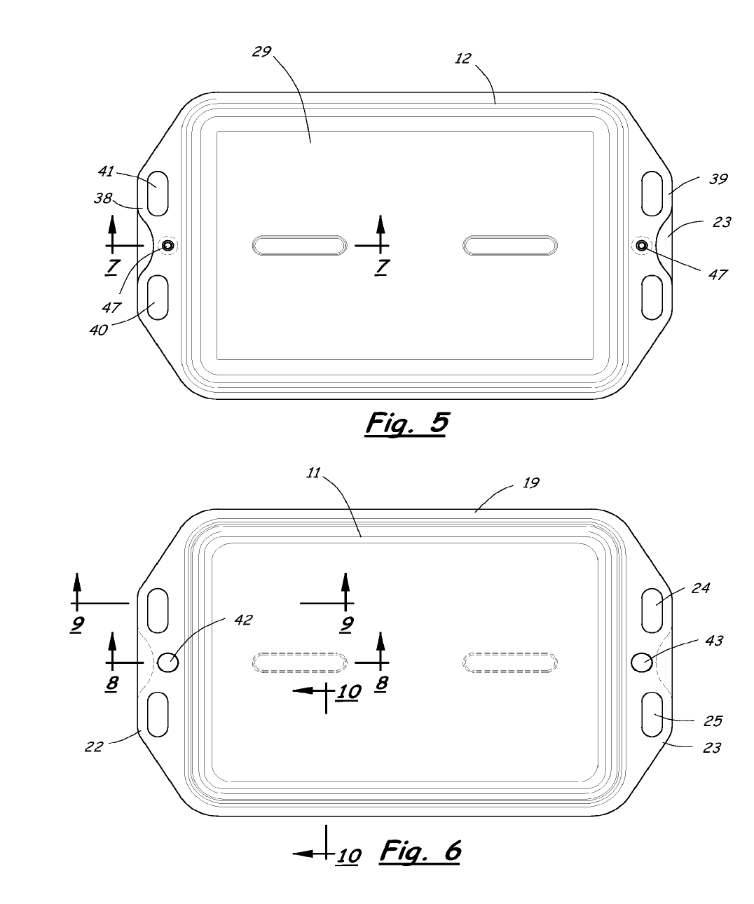

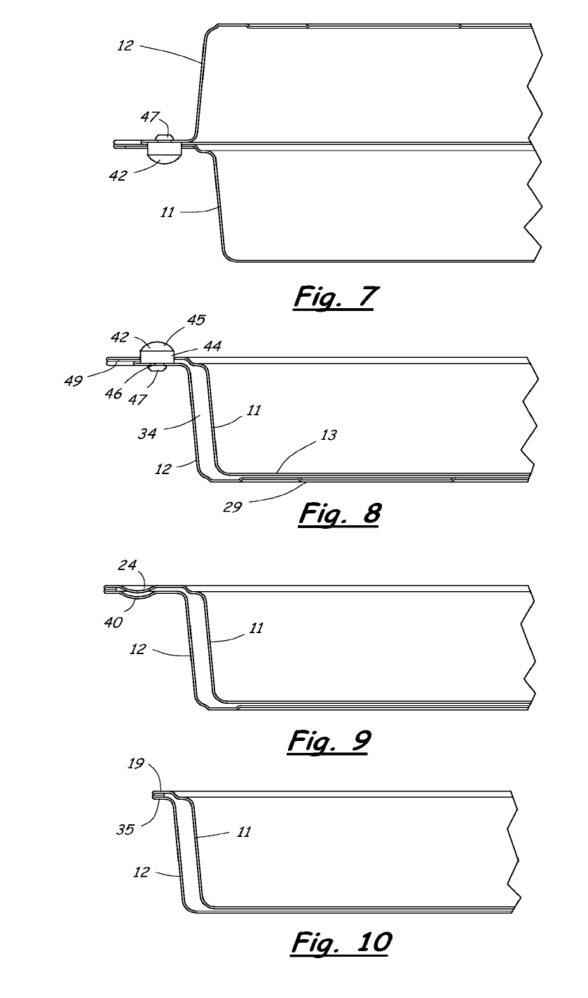

Insulated cooking utensils, including a cake pan 10 and a cookie sheet 100, according to the present invention will now be described in detail with reference to FIGS. 1 to 21 of the accompanying drawings.

The insulated cooking utensil 10 shown in FIGS. 1 to 18 is in the form of a cake pan having a substantially rectangular configuration. However, it will be understood by persons skilled in the art that some of the basic features of the present invention can be applied to other insulated cooking utensils, such as cookie sheets, bread pans, and the like.

The cooking utensil 10 includes a first pan 11 and a second pan 12. The first pan 11 is in the form of a cake pan having a generally rectangular configuration with a bottom 13, a pair of upstanding sidewalls 14, 15, and a pair of upstanding end walls 16, 17. The upstanding sidewalls 14, 15 and end walls 16, 17 extend around the outer periphery of the bottom 13 and are continuous at the four corners. The first pan 11 has a cooking surface 18 defined by the top side of the bottom 13 and the facing sides of the upstanding walls 14-17 (i.e., the surfaces that touch the food item contained in the pan). The first pan 11 can be manufactured, for example, by pressing a sheet of aluminum into the shape of a cake pan or other desired shape.

The cooking surface 18 of the first pan 11 is covered by a clear anodized finish coating. The clear anodized finish coating can be formed by well known sulfuric acid anodizing processes. For practical purposes, both sides of the aluminum sheet used to make the first pan 11 may be anodized as the aluminum material is dipped into an anodizing solution. The anodized surface provides the benefits of a hard surface resistant to scratching, and a heat absorbing surface that provides faster baking.

A peripheral lip 19 extends around the periphery of the upper edge of the first pan 11. The lip 19 has relatively narrow portions 20 along the upper edges of the sidewalls 14, 15, and tapers outwardly to relatively wide portions 21 along the upper edges of the end walls 16, 17. The wide portions 21 of the peripheral lip 19 attached to the end walls 16, 17 provide a pair of handles 22, 23 extending outwardly from respective ends of the first pan 11. The handles 22, 23 each have a pair of thumb grip areas 24, 25 formed therein to facilitate handling during baking and transport. The thumb grip areas 24, 25 comprise concave recesses pressed into the handles 22, 23, which extend in a longitudinal direction of the handles 22, 23.

First and second openings 26, 27 are also formed in the handles 22, 23 of the first pan 11. The openings 26, 27 comprise part of an alignment structure 28, which is described below.

The second pan 12 has a shape corresponding to the first pan 11 so that the first pan 11 can be nested within the second pan 12. Specifically, the second pan 12 has a generally rectangular configuration with a bottom 29, a pair of upstanding sidewalls 30, 31, and a pair of upstanding end walls 32, 33. The upstanding sidewalls 30, 31 and end walls 32, 33 of the second pan 12 extend around the outer periphery of the bottom 29 and are continuous at the four corners. The second pan 12 has a slightly larger dimension than the first pan 11 so that when the two pans 11, 12 are nested together, an air chamber 34 is interposed between the bottom surface, sidewalls and end walls of the first and second pans 11, 12. The second pan 12 can be manufactured, for example, by pressing a sheet of aluminum into a shape to correspond with the shape of the first pan 11.

A peripheral lip 35 extends around the periphery of the upper edge of the second pan 12. The lip 35 has relatively narrow portions 36 along the upper edges of the sidewalls 30, 31, and tapers outwardly to relatively wide portions 37 along the upper edges of the end walls 32, 33. The wide portions 37 of the peripheral lip 35 attached to the end walls 32, 33 provide a pair of handles 38, 39 extending outwardly from respective ends of the second pan 12. The handles 38, 39 each have a pair of thumb grip areas 40, 41 formed therein to facilitate handling during baking and transport. The thumb grip areas 40, 41 comprise concave recesses pressed into the handles at locations corresponding to the thumb grip areas 24, 25 formed in the handles 22, 23 of the first pan 11.

An alignment structure 28 is provided for aligning the first pan 11 relative to the second pan 12 when the pans are assembled together. The alignment structure 28 includes first and second guide members 42, 43 protruding upwardly from the handles 38, 39 of the second pan 12. The guide members 42, 43 each have a cylindrical base 44 and a dome-shaped upper surface 45. The guide members 42, 43 can be permanently fixed to the handles 38, 39 by passing a reduced diameter section 46 at one end of the guide members 42, 43 through an opening in the handles 38, 39 and spreading the end 47 of the reduced diameter section 46 using a press or the like to provide a rivet-like attachment. The guide members 42, 43 can also be secured to the handles 38, 39 by welding or by using separate fasteners, such as screws or rivets.

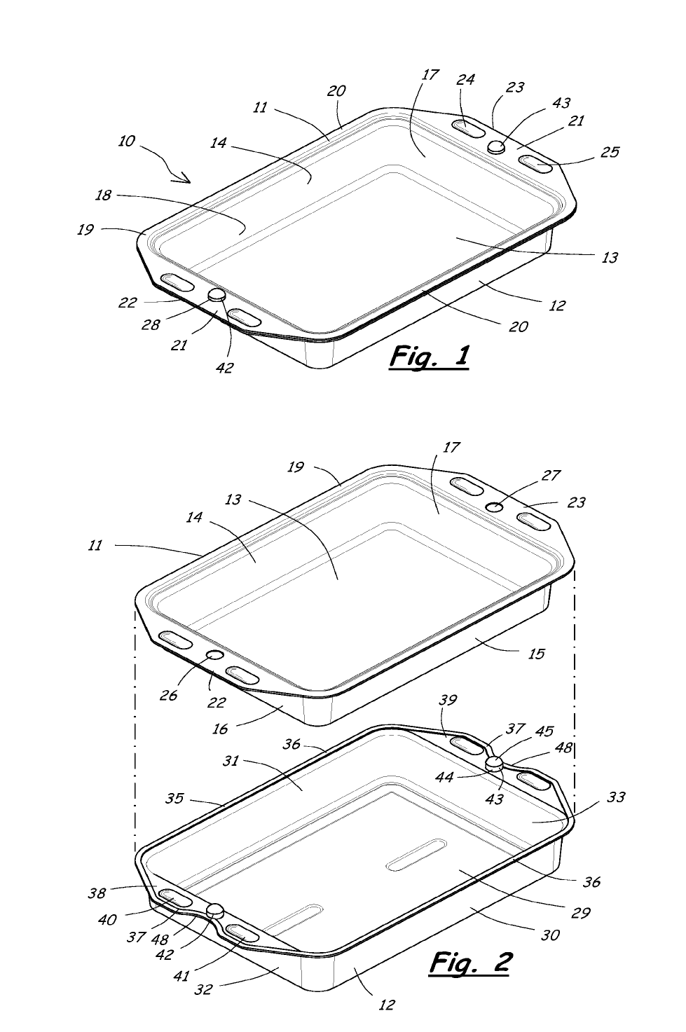

The first and second pans 11, 12 are assembled together in a first configuration for cooking, as shown in FIGS. 1 and 2. The guide members 42, 43 on the handles 38, 39 of the second pan 12 are mated with the first and second openings 26, 27 in the handles 22, 23 of the first pan 11. The dome-shaped upper surfaces 45 of the guide members 42, 43 function to self-center the guide members 42, 43 within the first and second openings 26, 27 during the assembly. In this configuration, the first pan 11 is nested within the second pan 12 with an insulating air chamber 34 interposed between the first and second pans 11, 12 for insulating the cooking surface 18 of the first pan 11 from direct heat during cooking operations. The insulating air chamber 34 is maintained between the bottoms 13, 29 of the first and second pans 11, 12 by the peripheral lip 19 of the first pan 11 resting on the peripheral lip 35 of the second pan 12. The insulating air chamber 34 is maintained between sides and ends of the first and second pans 11, 12 by the alignment structure 28, including the guide members 42, 43 on the handles 38, 39 of the second pan 12 and the openings 26, 27 in the handles 22, 23 of the first pan 11.

When the first and second pans 11, 12 are assembled in the first configuration, as shown in FIG. 1, the handles 38, 39 of the second pan 12 are generally coextensive with the handles 22, 23 of the first pan 11. However, as shown in FIG. 2, the handles 38, 39 of the second pan 12 have respective cutaway portions 48 formed therein to expose a portion of the lower surface 49 of the handles 22, 23 of the first pan 11 to facilitate lifting the first pan 11 from the second pan 12. In the embodiment shown in FIG. 2, the cutaway portions 48 are inwardly curved areas formed in the outer edge of the handles 38, 39 of the second pan 12.

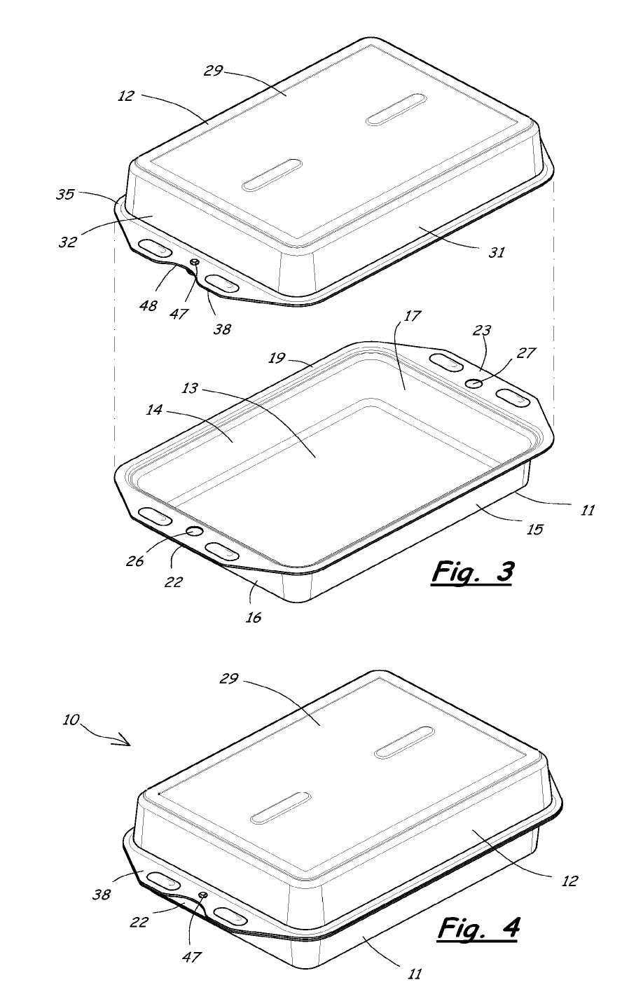

The first and second pans 11, 12 can also be assembled together in a second configuration, as shown in FIGS. 3 and 4. In the second configuration, the second pan 12 is turned upside down (relative to its position in the first configuration shown in FIG. 1), and placed over the first pan 11 as a protective cover. The same alignment structure 28 is used to align the second pan 12 with the first pan 11 in the second configuration as in the first configuration. As the second pan 12 is lowered onto the first pan 11 in the second configuration, the dome-shaped surfaces 45 of the guide members 42, 43 function to self-center the guide members 42, 43 within the first and second openings 26, 27.

The first and second pans 11, 12 are easily convertible between the first and second configurations. This allows the cooking utensil 10 to be used as an insulated cooking utensil with an insulating air chamber 34 interposed between the first and second pans 11, 12 in the first configuration. The same cooking utensil 10 can then be converted into a container for transporting baked items with a tall and durable protective cover over the open top of the first pan 11. This allows relatively tall decorations, such as birthday candles and the like, to be covered and protected during transport without disturbing the decorations. The separable first and second pans 11, 12 also allow the cooking utensil 10 to be thoroughly washed and dried without risk of wash water becoming trapped in the insulating air chamber 34.

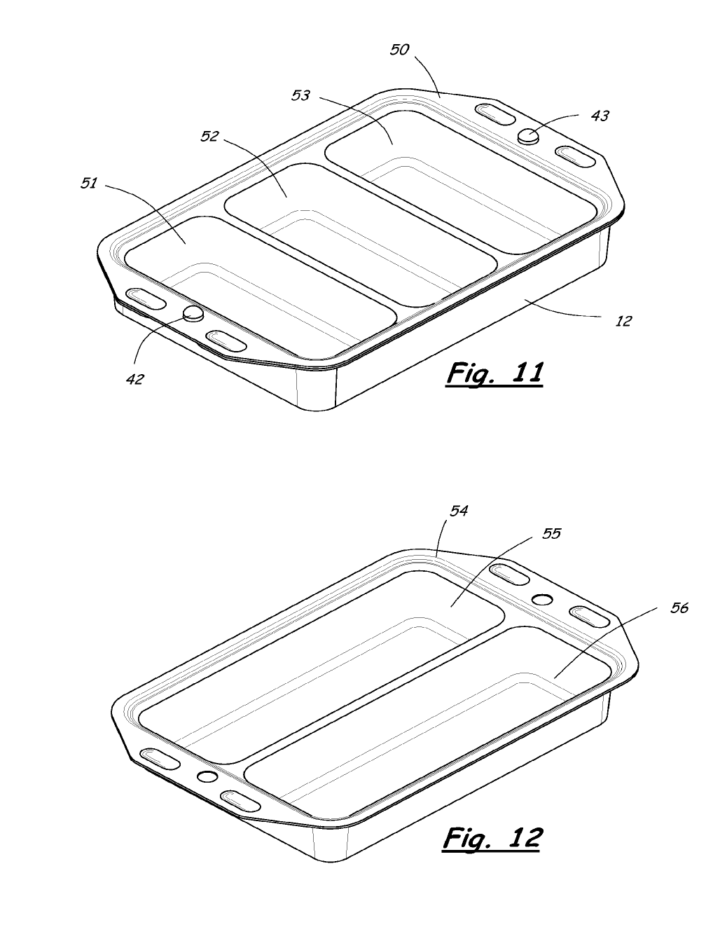

As shown in FIGS. 11 and 12, the first pan 11 of the cooking utensil 10 can be interchanged with third pans having a different baking shape and purpose, such as bread pans, nut bread pans, lasagna pans, muffin pans, and so forth. As shown in FIG. 11, the third pan 50 can have a plurality of loaf sections 51, 52, 53 arranged side-by-side and extending in a lateral direction. As shown in FIG. 12, the third pan 54 can have a plurality of loaf sections 55, 56 arranged side-by-side and extending in a longitudinal direction.

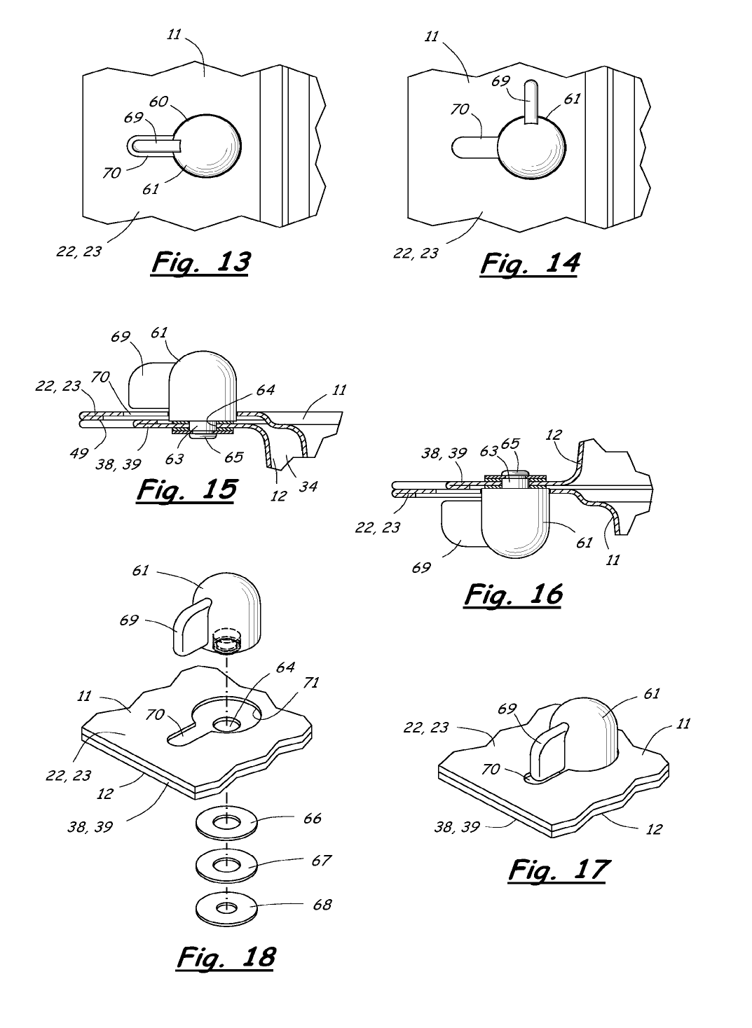

A locking mechanism 60 for selectively locking and unlocking the first and second pans 11, 12 together is shown in FIGS. 13 to 18. The locking mechanism 60 includes first and second latch structures 61 rotatably attached to the respective handles 38, 39 of the second pan 12 in place of the first and second guide members 42, 43 described above. The latch structures 61 are manually rotatable (e.g., by approximately 90 to 180 degrees) between an unlocked position, as shown in FIG. 13, and a locked position, as shown in FIG. 14.

The latch structures 61 are rotatably attached to the handles 38, 39 of the second pan 12 by passing a reduced diameter section 63 of each latch structure 61 through a mounting hole 64 in the respective handle 38, 39, and then spreading the end 65 of the reduced diameter section 63 to keep it from pulling back through the mounting hole 64. Washers 66, 67, 68 are placed on the reduced diameter section 63 above and below the respective handles 38, 39 to ensure smooth rotational movement of the latch structures 61.

The latch structures 61 each have a key section 69 protruding radially outwardly from the outer surface thereof. Slots 70 are formed adjacent to the alignment openings 71 in the handles 22, 23 of the first pan 11, which correspond in shape to the key sections 69 protruding from the latch structures 61 of the second pan 12. The slots 70 are arranged to allow the latch structures 61 to pass through the openings 71 of the first pan 11 when assembling the first and second pans 11, 12 together, and to prevent the latch structures 61 from passing through the openings 71 when the latch structures 61 are in their locked positions. When the first and second pans 11, 12 are assembled in their first configuration, the latch structures 61 are located above the handles 22, 23 of the first pan 11, as shown in FIG. 15. When the first and second pans 11, 12 are assembled in their second configuration, the latch structures 61 are located below the handles 22, 23 of the first pan 11, as shown in FIG. 16.

In use, the insulated cooking utensil 10 can be assembled together with the first pan 11 nested in the second pan 12 and the locking mechanism 60 engaged to secure the first and second pans 11, 12 together. With the first and second pans 11, 12 assembled in this configuration, a food item, such as a cake, can be baked using conventional techniques suitable for insulated cooking utensils. The insulating air chamber 34 between the first and second pans 11, 12 provides more uniform baking and insulates the cooking surface 18 from the intense radiation of the heating element in the lower part of the oven to improve the cooking process.

After the food item is baked and/or decorated, the first and second pans 11, 12 can then be unlocked from each other, and the first pan 11 lifted out of the second pan 12. This allows easy washing of the pans 11, 12 without concern for getting wash water trapped inside of the insulating air chamber 34. This also allows the second pan 12 to be turned over and placed upside down on top of the first pan 11 with the guide members 42, 43 again mated with the openings 26, 27 in the handles 22, 23 of the first pan 11. The locking mechanism 60 can then be engaged to secure the first and second pans 11, 12 together with the second pan 12 functioning as a protective cover.

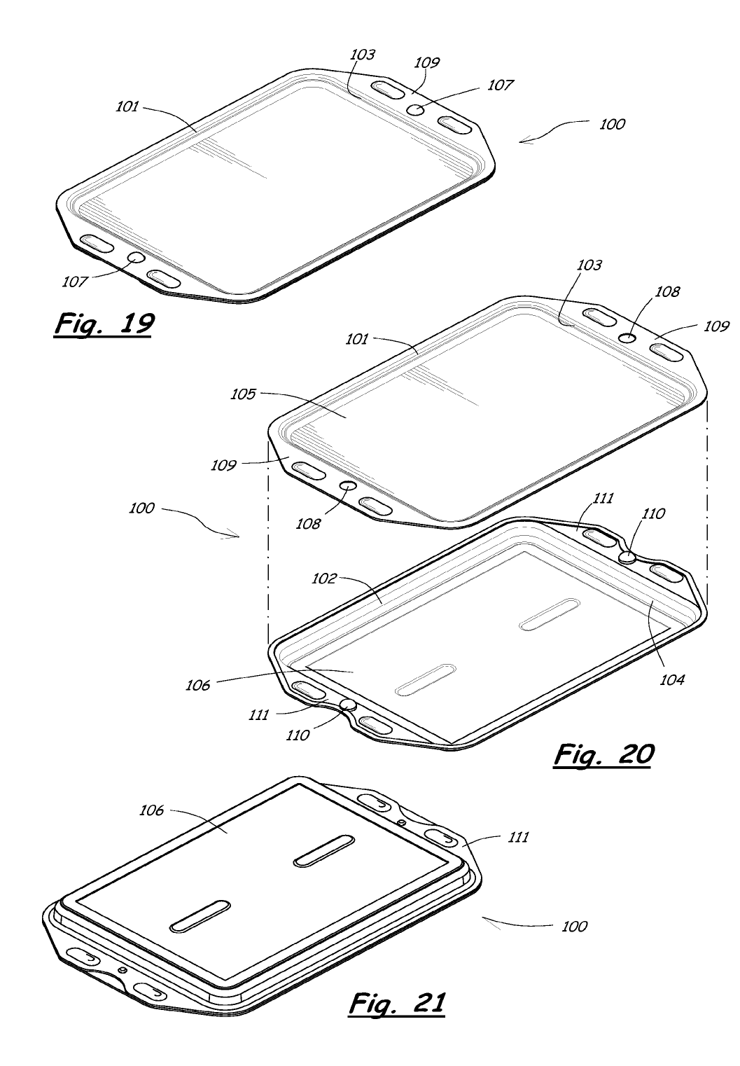

FIGS. 19 to 21 show another embodiment of the present invention in which the insulated cooking utensil 100 is an insulated cookie sheet incorporating features of the present invention. The structure of the insulated cookie sheet 100 in this embodiment is similar to the structure of the insulated cake pan 10 described above, except that the sidewalls 101, 102 and end walls 103, 104 of the first and second pans 105, 106, respectively, have a lower profile to give the utensil 100 a generally planar configuration to function as a cookie sheet.

An alignment system 107 is provided on the handles at each end of the cookie sheet 100, similar to the alignment system 28 in the other embodiments described above. The alignment system 107 includes openings 108 formed in the handles 109 of the first pan 105, and guide members 110 protruding from the handles 111 of the second pan 106 for mating with the openings 108 of the first pan 105. The alignment system 107 functions to align and maintain an insulating air space between the first and second pans 105, 106 when the utensil 100 is assembled into a first configuration for baking, as shown in FIG. 19. The alignment system 107 also functions to align and maintain the second pan 106 in position on the first pan 105 when the utensil 100 is assembled into a second configuration for use as a container with a protective cover, as shown in FIG. 21. The alignment system 107 has a lower profile in this embodiment to minimize the overall height of the insulated cookie sheet 100. As in the other embodiments described above, a latching mechanism can be used to selectively lock the first and second pans 105, 106 of the cookie sheet 100 together, while allowing the pans 105, 106 to be unlocked and separated for washing.

While the invention has been specifically described in connection with specific embodiments thereof, it is to be understood that this is by way of illustration and not of limitation, and the scope of the appended claims should be construed as broadly as the prior art will permit.

What is claimed is:

1. An insulated cooking utensil, comprising:
a first pan having a cooking surface;
a second pan having a shape corresponding to the first pan so that the first and second pans can be assembled together with an insulating air chamber interposed between the first and second pans for insulating the cooking surface of the first pan from direct heat during a cooking operation; and
an alignment means for aligning the first pan relative to the second pan when the pans are assembled together and for allowing the first and second pans to be separated from each other.

2. The insulated cooking utensil according to claim 1, wherein said alignment means comprises first and second guide members protruding from said second pan, and first and second openings formed in said first pan for receiving said guide members.

3. The insulated cooking utensil according to claim 2, further comprising a locking mechanism for selectively locking and unlocking the first and second pans together.

4. The insulated cooking utensil according to claim 1, wherein said first pan comprises a baking pan having an overall rectangular configuration with a bottom surface and a plurality of upstanding sidewalls and end walls extending around the outer periphery of the bottom surface, and said second pan has a shape corresponding to the first pan so that the first pan can be nested within the second pan with said air chamber interposed between the bottom surface, sidewalls and end walls of the first pan and corresponding parts of the second pan.

5. The insulated cooking utensil according to claim 1, wherein said first and second pans each have a pair of handles extending outwardly from respective ends thereof, and wherein said alignment means comprises a mating structure built into said handles.

6. The insulated cooking utensil according to claim 5, wherein said handles of said second pan are generally coextensive with said handles of said first pan and have respective cutaway portions formed therein to expose a portion of the lower surface of the handles of the first pan to facilitate lifting the first pan from the second pan.

7. The insulated cooking utensil according to claim 5, wherein said handles have recessed thumb grip areas formed therein to facilitate handling.

8. The insulated cooking utensil according to claim 5, wherein said alignment means comprises first and second guide members protruding upwardly from the handles of said second pan, and first and second openings formed in the handles of said first pan for receiving said guide members.

9. The insulated cooking utensil according to claim 8, wherein said first and second guide members have dome-shaped upper surfaces that self-center the guide members within the first and second openings as the first and second pans are assembled together.

10. The insulated cooking utensil according to claim 8, further comprising a locking mechanism for selectively locking and unlocking the first and second pans together.

11. The insulated cooking utensil according to claim 10, wherein said locking mechanism comprises first and second latch structures associated with said first and second guide members which can be manually rotated between locked and unlocked positions.

12. The insulated cooking utensil according to claim 11, wherein said locking mechanism further comprises slots formed adjacent to said first and second openings for allowing said latch structure to pass through said first pan when assembling the first and second pans together.

13. The insulated cooking utensil according to claim 1, wherein said cooking utensil is convertible from a first configuration in which the first pan is nested within the second pan with said insulating air chamber interposed between the first and second pans, and a second configuration in which the second pan is turned upside down and placed over the first pan as a protective cover.

14. The insulated cooking utensil according to claim 13, wherein said alignment means aligns the first and second pans relative to each other in both said first and second configurations.

15. The insulated cooking utensil according to claim 1, further comprising a third pan having a cooking surface with a different shape than the cooking surface of the first pan, said third pan being interchangeable with said first pan to provide a different shaped cooking surface and function.

16. The insulated cooking utensil according to claim 1, wherein said first and second pans are both formed of aluminum material.

17. The insulated cooking utensil according to claim 16, wherein said cooking surface of the first pan is covered with a clear anodized coating.

18. The insulating cooking utensil according to claim 1, wherein said second pan is larger than said first pan to create said insulating air chamber between the first and second pans when assembled in a first configuration for cooking, and wherein said insulating air chamber is maintained by the first pan resting on an upper edge of the second pan and by the alignment means.

19. The insulated cooking utensil according to claim 1, wherein said first pan comprises a cookie sheet with a generally planar configuration, and said second pan has a shape corresponding to the first pan so that the first pan can be assembled together with the second pan with said air chamber interposed therebetween.

20. A convertible cooking utensil, comprising:
a first pan having a cooking surface;
a second pan having a shape corresponding to the first pan; and
an alignment structure for aligning the first pan relative to the second pan when the pans are assembled together and for allowing the first and second pans to be separated from each other,
said cooking utensil being convertible from a first configuration in which the first pan is nested within the second pan with an insulating air chamber interposed between the first and second pans, and a second configuration in which the second pan is turned upside down and placed over the first pan as a protective cover.

21. The convertible cooking utensil according to claim 20, wherein said alignment structure aligns the first and second pans relative to each other in both said first and second configurations.

22. The convertible cooking utensil according to claim 21, further comprising a locking mechanism for selectively locking and unlocking the first and second pans together in both said first and second configurations.

23. The convertible cooking utensil according to claim 22, wherein said alignment structure comprises first and second alignment structures, and further comprising first and second latch structures associated with said first and second alignment structures which can be manually rotated between locked and unlocked positions.

24. The convertible cooking utensil according to claim 20, wherein said first and second pans each have a pair of handles extending outwardly from respective ends thereof, and wherein said alignment structure comprises guide members protruding upwardly from the handles of said second pan and openings formed in the handles of said first pan for receiving said guide members.

25. The convertible cooking utensil according to claim 24, wherein said guide members comprise dome-shaped upper surfaces that self-center the guide members within the openings as the first and second pans are assembled together, and wherein said guide members further comprise locking mechanisms which can be manually rotated between locked and unlocked positions.
